(19) United States
(12) Patent Application Publication
(10) Pub. No.: US 2025/0173834 A1
(43) Pub. Date: May 29, 2025

(54) Method Of Image-To-Image Translation Using Diffusion Model

(71) Applicant: SI Analytics Co., Ltd., Daejeon (KR)

(72) Inventors: Minseok SEO, Daejeon (KR); Dongmin KANG, Daejeon (KR); Youngtack OH, Daejeon (KR); Doyi KIM, Daejeon (KR); Yeji CHOI, Sejong-si (KR)

(73) Assignee: SI Analytics Co., Ltd., Daejeon (KR)

(21) Appl. No.: 18/769,297

(22) Filed: Jul. 10, 2024

(30) Foreign Application Priority Data
Nov. 24, 2023 (KR) 10-2023-0165484

(51) Int. Cl. G06T 5/60; G06T 5/70; G06T 11/00

(52) U.S. Cl. CPC G06T 5/60; G06T 5/70; G06T 11/00; G06T 2207/10044; G06T 2207/20081

(57) ABSTRACT

Disclosed is a method for training a diffusion model for image-to-image translation, which is performed by a computing device. The method may include: obtaining an image of a target domain; sampling random noise from a distribution of a source domain; and training a diffusion model that translates an image of the source domain to the image of the target domain based on the sampled noise.

### CROSS-REFERENCE TO RELATED APPLICATIONS

This application claims priority to and the benefit of Korean Patent Application No. 10-2023-0165484 filed in the Korean Intellectual Property Office on Nov. 24, 2023, the entire contents of which are incorporated herein by reference.

### TECHNICAL FIELD

The present disclosure relates to a method of translating an image from a synthetic aperture radar (SAR) satellite image to an electro-optical (EO) satellite image, and more particularly, to a method of translating the SAR satellite image to the EO satellite image using a diffusion model.

### BACKGROUND ART

Due to rapid climate change, the frequency and intensity of flood cases are increasing. Electronic-optical (EO) satellite images are widely used for quick response. A sensor of the EO satellite produces an image by receiving the light coming to the surface of the earth and receiving the light coming back. Due to the use of visible light, in the area of interest is covered with clouds or in the night without light or in bad weather, image information which can be obtained is limited. Therefore, the sensor of the EO satellite is not suitable for a task of monitoring the floods caused by heavy rains with thick clouds.

The sensor of the synthetic aperture radar (SAR) satellite, after radiation of microwaves, detects the electromagnetic energy scattered by the observation object with an antenna and implements the shape of the ground object into image through the analysis. Therefore, it is possible to obtain an image by penetrating through clouds, and it is possible to obtain an image unaffected by a weather situation and time. An SAR image has an advantage of identifying the physical characteristics of the terrain.

However, the SAR image are very low in resolution and are very sensitive to electromagnetic characteristics on the ground surface. In other words, depending on the characteristics of the ground surface, the microwave bumps and the scattering is greatly changed, and a lot of speckle noise occurs. In addition, it is difficult to an interpret the data due to the essentially different data representation from the EO image.

This difficulty in interpretation requires an annotated data when training the model. In particular, since the automated disaster monitoring model is based on neural networks, the model relies heavily on data (heavily data-driven). Thus, when the model is trained with a small amount of training data, problems such as overfitting, decrease in generalization capability, etc., can occur.

In addition, the denoising technology of SAR satellite images is being studied to remove the speckle noise to improve the interpretation ability of the SAR satellite image. However, the denoising technology of such SAR satellite images removes only noise, and does not generate an image in which a color or an object of the image is corrected, so the denoising technology shows an effect in a limited environment.

On the other hand, since the EO satellite image is intuitive, image translation technology from the SAR satellite image to the EO satellite image has been recently studied. For example, there is a Pix2Pix-based technology using GAN. However, the GAN-based model has a mode collapse problem that greatly reduces the quality of the generated data. In addition, all of the existing Pix2pix-based methods that translate the SAR satellite image to the EO satellite image require a registered image between the SAR satellite image and the EO satellite image for training.

Korean Patent Unexamined Publication No. 10-2022-0098218 (Jul. 11, 2022) discloses image-to-image translation method using unpaired data for supervised learning.

### SUMMARY OF THE INVENTION

The present disclosure has been made in an effort to provide a method of predicting an EO satellite image with a ground truth image from an SAR satellite image by adjusting the diversity of a diffusion model.

Meanwhile, a technical object to be achieved by the present disclosure is not limited to the above-mentioned technical object, and various technical objects can be included within the scope which is apparent to those skilled in the art from contents to be described below.

An exemplary embodiment of the present disclosure provides a method for training a diffusion model for image-to-image translation, which is performed by a computing device. The method may include: obtaining an image of a target domain; sampling any noise in a distribution of a source domain; and training a diffusion model that translates the image of the source domain to the image of the target domain based on the sampled noise.

As an exemplary embodiment, the method may further include generating the distribution of the source domain by converting a mean and a dispersion of a standard normal distribution into a mean and a dispersion of the distribution of the source domain.

As an exemplary embodiment, the training of the diffusion model may include training mapping from the target domain to the source domain in a latent space.

As an exemplary embodiment, the training of mapping from the target domain to the source domain in the latent space may include adding the sampled noise to the image of the target domain for each step in a forward diffusion process, and removing noise estimated in a reference image of the source domain for each step in a reverse diffusion process.

As an exemplary embodiment, the method may further include setting random noise added for each step to 0 in the reverse diffusion process.

As an exemplary embodiment, the adding of the sampled noise to the image of the target domain may include extracting a latent feature of the target domain from the image of the target domain, and converting the latent feature of the target domain into a latent representation of the source domain by adding the sampled noise to the latent feature of the target domain.

As an exemplary embodiment, the training of the diffusion model may include training the diffusion model by using additional information of the image of the source domain as a condition in the reverse diffusion process.

As an exemplary embodiment, the training of the diffusion model by using additional information of the image of the source domain as the condition may include projecting the additional information of the image of the source domain to an intermediate representation of Unet, and mapping the projection result to an intermediate layer of the Unet through a cross attention layer.

As an exemplary embodiment, the image of the source domain may include multi-temporal images which are spatially registered and temporally randomly selected.

As an exemplary embodiment, the additional information of the image of the source domain may include temporal information of the image of the source domain or topographical information of the image of the source domain.

Another exemplary embodiment of the present disclosure provides a method of performing image-to-image translation using a diffusion model, which is performed by a computing device. The method may include: obtaining an original image of a source domain; performing preprocessing of removing noise of the original image by using a diffusion model; and translating the preprocessed image to a synthetic image of a target domain, and the diffusion model may gradually remove noise from the preprocessed image through a trained denoising process, and translates the preprocessed image from which the noise is removed to the synthetic image of the target domain.

Further, yet another exemplary embodiment of the present disclosure provides a computer program stored in a computer-readable storage medium. The computer program may allow one or more processors to perform operations for training a diffusion model for image-to-image translation when the computer program is executed by one or more processors, and the operations may include: an operation of obtaining an image of a target domain; an operation of sampling any noise in a distribution of a source domain; and an operation of training a diffusion model that translates an image of a source domain to the image of the target domain based on the sampled noise.

Stilly yet another exemplary embodiment of the present disclosure provides a computing device. The computing device may include: at least one processor; and a memory, and the at least one processor may be configured to obtain an image of a target domain, sample any noise in a distribution of a source domain, and train a diffusion model that translates an image of a source domain to the image of the target domain based on the sampled noise.

According to an exemplary embodiment of the present disclosure, there is an effect in that by predicting an EO satellite image with a ground truth image from an SAR satellite image by adjusting the diversity of a diffusion model, an image can be predict with clarity and high accuracy. Accordingly, there is an effect in that a decoding capability of the SAR satellite image can be enhanced.

Further, there is an effect in that since the SAR satellite image can be translated to the EO satellite image which is easily decoded by a person, an improved insight for accurate flood monitoring can be provided.

Meanwhile, the effects of the present disclosure are not limited to the above-mentioned effects, and various effects can be included within the scope which is apparent to those skilled in the art from contents to be described below.

### BRIEF DESCRIPTION OF THE DRAWINGS

FIG. 1 is a block diagram of a computing device performing operations according to an exemplary embodiment of the present disclosure.

FIG. 2 is a schematic view illustrating a neural network according to an exemplary embodiment of the present disclosure.

FIG. 3 is a flowchart for describing a method for training a diffusion model for image-to-image translation according to an exemplary embodiment of the present disclosure.

FIG. 4 is a conceptual view for describing a Brownian bridge diffusion model according to a comparative example of the present disclosure.

FIG. 5 is a block diagram of an image translation system according to an exemplary embodiment of the present disclosure.

FIG. 6 is a diagram for describing a sampling process according to an exemplary embodiment of the present disclosure.

FIG. 7 is a flowchart for describing a method of performing image-to-image translation using a diffusion model according to an exemplary embodiment of the present disclosure.

FIGS. 8A, 8B, 8C, and 8D are diagrams for describing an image from which noise is removed using a self supervised scheme according to an exemplary embodiment of the present disclosure.

FIGS. 9A, 9B, 9C, and 9D are diagrams for describing a synthetic EO satellite image generated through the method of image-to-image translation according to an exemplary embodiment of the present disclosure.

FIG. 10 is a diagram for describing a synthetic EO satellite image generated through the method of image-to-image translation according to an exemplary embodiment of the present disclosure.

FIG. 11 is a simple and normal schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

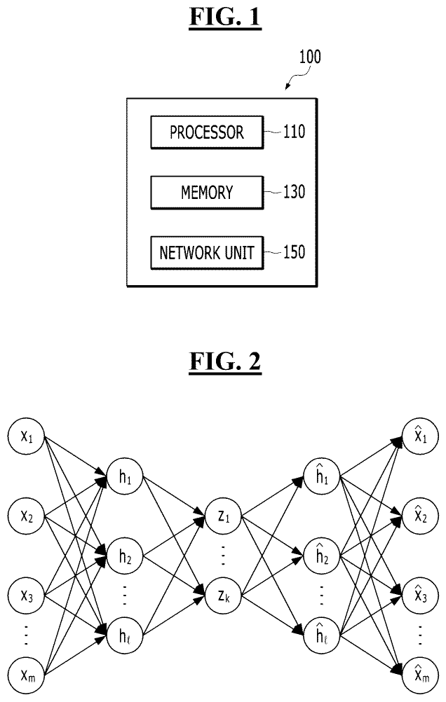

FIG. 1 is a block diagram of a computing device performing actions according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of a plurality of computing devices may be used together to process the learning of the network function and the data classification using the network function. Further, the computer program executed in the computing device according to an exemplary embodiment of the present disclosure may be a CPU, GPGPU, or TPU executable program.

The computing device 100 according to an exemplary embodiment of the present disclosure may be an image translation system. The image translation system receives an SAR satellite image to generate a clean synthetic EO satellite image. That is, the synthetic EO satellite image similar to the EO satellite image may be generated from the SAR satellite image. The SAR satellite image corresponding to the synthetic EO satellite image is provided to analyzers to provide an enhanced insight for flood monitoring.

The image translation system may include a diffusion model that translates the SAR satellite image to the EO satellite image. Since contexts of the SAR satellite image to the EO satellite image are the same as each other, a gradual improvement process of the diffusion model may give a bit help to image translation performance improvement.

In general, the diffusion model shows a best performance in a task such as image generation. The diffusion model is widely applied even to a satellite image field. However, in a task that aims at prediction in the state in which a correct answer is given, the diversity of the diffusion model may serve as a disturbance factor in the process of reading the image by a person.

Since the image translation system according to an exemplary embodiment of the present disclosure is a model that predicts the EO satellite image with a ground truth image from the SAR satellite image, a term of adjusting the diversity is modified in the diffusion model to generate the synthetic EO satellite image similar to the EO satellite image from the SAR satellite image.

As a method for training the diffusion model for image-to-image translation according to an exemplary embodiment of the present disclosure, the computing device 100 may obtain an image of a target domain. The image of the target domain may mean the EO satellite image.

The computing device 100 may sample any noise in a distribution of a source domain. The distribution of the source domain may mean a distribution of values observed in the SAR satellite image.

The computing device 100 may train a diffusion model that translates an image of the source domain to the image of the target domain based on the sampled noise.

According to an exemplary embodiment of the present disclosure, instead of Gaussian noise that follows a standard normal distribution for each step in a forward diffusion process, the noise sampled in the distribution of the source domain may be added to the image of the target domain. Estimated noise from a reference image of the source domain for each step in a reverse diffusion process may be removed. Random noise added for each step in the reverse diffusion process may be set to 0.

Accordingly, by using the trained diffusion model, an image similar to an actual EO satellite image or similar to a training EO image may be generated instead of generating various textures and colors. That is, an image-to-image translation task may be made to be closer to the prediction.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to several embodiments of the present disclosure may use various wired communication systems, such as a Public Switched Telephone Network (PSTN), an x Digital Subscriber Line (xDSL), a Rate Adaptive DSL (RADSL), a Multi Rate DSL (MDSL), a Very High Speed DSL (VDSL), a Universal Asymmetric DSL (UADSL), a High Bit Rate DSL (HDSL), and a local area network (LAN).

The network unit 150 presented in the present specification may use various wireless communication systems, such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems.

In the present disclosure, the network unit 150 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth. The techniques described herein may be used in other networks in addition to those mentioned above.

FIG. 2 is a schematic diagram illustrating a network function according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data. As another example, in the case of the unsupervised learning related to the data classification, the training data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the training data may be generally a subset of actual data (i.e., data to be processed using the learned neural network), and as a result, there may be a learning cycle in which errors for the training data decrease, but the errors for the actual data increase. Overfitting is a phenomenon in which the errors for the actual data increase due to excessive learning of the training data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of learning, utilization of a batch normalization layer, etc., may be applied.

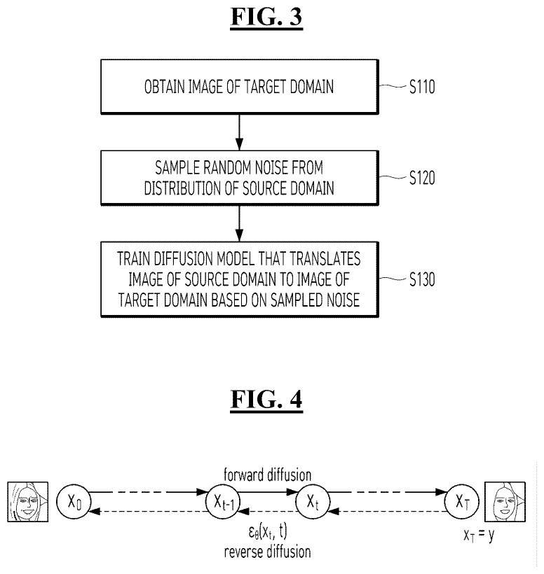

FIG. 3 is a flowchart for describing a method for training a diffusion model for image-to-image translation according to an exemplary embodiment of the present disclosure.

Referring to FIG. 3, the computing device 100 may obtain an image of a target domain (S110). The image of the target domain may mean the EO satellite image.

The computing device 100 may sample random noise in a distribution of a source domain (S120). The distribution of the source domain may mean a distribution values observed in the SAR satellite image. The distribution of the source domain may be generated by converting a mean and a dispersion of a standard normal distribution into a mean and a dispersion of the distribution of the source domain.

The computing device 100 may train a diffusion model that translates an image of the source domain to the image of the target domain based on the sampled noise (S130). That is, when a dataset is given, which is constituted by the image of the target domain and the image of the source domain, the computing device 100 may train mapping from the target domain to the source domain in a latent space.

According to an exemplary embodiment of the present disclosure, instead of Gaussian noise that follows a standard normal distribution for each step in a forward diffusion process, the noise sampled in the distribution of the source domain may be added to the image of the target domain. Estimated noise in a reference image of the source domain for each step in a reverse diffusion process may be removed. Random noise added for each step in the reverse diffusion process may be set to 0.

Accordingly, by using the trained diffusion model, an image similar to an actual EO satellite image or similar to a training EO image may be generated instead of generating various textures and colors. That is, an image-to-image translation task may be made to be closer to the prediction.

FIG. 4 is a conceptual view for describing a Brownian bridge diffusion model according to a comparative example of the present disclosure

In the present disclosure, a probability process of image translation in the latent space may be modeled by using a Brownian Bridge Formula.

Most existing diffusion models handle the image-to-image translation as a conditional generative process, and suffer great losses due to a difference between different domains. In the present disclosure, as illustrated in FIG. 4, a new image-to-image translation method based on a Brownian bridge diffusion model (BBDM) is proposed, which models the image-to-image translation as a probabilistic Brownian bridge process, and directly trains translation between both domains through a bidirectional diffusion process other than the conditional generative process. That is, the forward diffusion process regards a clean conditional input y as a destination instead of ending in pure Gaussian noise.

### Brownian Bridge

A Brownian bridge is a continuous-time stochastic model in which a probability distribution depends on a condition for a start state and an end state during a diffusion process. Specifically, a state distribution in each time step of a Brownian bridge process which starts at a point x0 to qdata(x0) in t=0 and ends at a point xT in t=T may be defined as in [Equation 1] below.

$$p ( {x}_{t} \vert {x}_{0} , {x}_{T} ) = 𝒩 ( ( 1 - \frac{t}{T} ) {x}_{0} + \frac{t}{T} {x}_{T} , \frac{t ( T - t )}{T} I ) \qquad [ Equation 1 ]$$

That is, the Brownian bridge process is limited at both ends x0 and xT, and a process therebetween may form a bridge.

When two datasets XA and XB which are sampled domains A and B, respectively, are given, the image-to-image translation aims at training mapping from domain A to domain B. In the present disclosure, the image-to-image translation may be performed based on the probabilistic Brownian bridge diffusion process.

Further, in the present disclosure, the diffusion process may be completed in a latent space of Vector Quantized Generative Adversarial Networks (VQGAN). When image sampled in domain A is given, latent feature may be first extracted. Then, the Brownian bridge process may map latent feature of domain A to a corresponding latent representation in domain B. Last, image translated in latent feature of domain B may be generated by a decoder of pre-trained VQGAN.

### Brownian Bridge Diffusion Model (BBDM)

The forward diffusion process of a denoising diffusion probabilistic model (DDPM) starts at clean data x0 to qdata(x0) and ends at the standard normal distribution. Setting of the DDPM is suitable for image generation, and a reverse inference process naturally maps the sampled noise to the image. However, the setting of the DDPM is not suitable for an image-to-image translation task between two different domains. Among the existing diffusion based image translation methods, most methods integrate a reference image into a conditional input of the reverse diffusion process to improve an original DDPM.

The present disclosure proposes an image-to-image translation method based on the Brownian bridge diffusion process different from the existing DDPM methods. That is, the forward diffusion process regards a clean conditional input y as a destination instead of ending in pure Gaussian noise.

The forward diffusion process of the Brownian bridge may be defined as in [Equation 2] below.

$$\begin{matrix}{q}_{BB} ( {x}_{t} \vert {x}_{0} , y ) = 𝒩 ( {x}_{t} ; ( 1 - {m}_{t} ) {x}_{0} + {m}_{t} y , {δ}_{t} I ) \\ {x}_{0} = x , \\ {m}_{t} = \frac{t}{T}\end{matrix} \qquad [ Equation 2 ]$$

Where T represents the total number of steps of the diffusion process, and δt means a dispersion.

When an original Brownian bridge dispersion represented in [Equation 1] is taken,

$${δ}_{t} = \frac{t ( T - t )}{T} , and {δ}_{T / 2} = \frac{T}{4}$$

which is a maximum dispersion of an intermediate step is extremely larger with the increase in T, so it is difficult to train a framework of the Brownian bridge diffusion model. When it is assumed that the dispersion of x0 follows the standard normal distribution, an identity of the dispersion of the intermediate step should be preserved. Accordingly, when it is assumed that x0,y to N(0,I) are relatively independent, a new dispersion schedule for the Brownian bridge diffusion process for preserving the dispersion may be designed as in [Equation 3] below.

$$\begin{matrix}{δ}_{t} = 1 - ( {( 1 - {m}_{t} )}^{2} + {m}_{t}^{2} ) \\ = 2 ( {m}_{t} - {m}_{t}^{2} )\end{matrix} \qquad [ Equation 3 ]$$

At a start (t=0) of the diffusion process, m0=0, and a mean value is the same as x0 having a probability of 1 and a dispersion of δ0=0. When the diffusion process reaches a destination (t=T), mT=1, and the mean is the same as y, but the dispersion becomes δT=0. During the diffusion process, the dispersion δt increases to δmax=δT/2=1/2 which is a largest value at an intermediate time, and then decreases up to δT=oat the destination of the diffusion. According to characteristics of the Brownian bridge diffusion process, sampling diversity may be controlled by the maximum dispersion at the intermediate step t=T/2. Accordingly, actually, the sampling diversity may be controlled by adjusting δt with a factor s as in [Equation 4] below.

$${δ}_{t} = 2 s ( {m}_{t} - {m}_{t}^{2} ) \qquad [ Equation 4 ]$$

According to a transition probability defined in [Equation 2], the forward diffusion of the Brownian bridge process provides only a marginal distribution at each step t. For training and inference, a forward transition probability q_{BB}(xₜ|xₜ₋₁, y) should be derived.

When initial state x0 and a destination state y are given, an intermediate state xt may be calculated as a discrete form as in [Equation 5] and [Equation 6] below.

$${x}_{t} = ( 1 - {m}_{t} ) {x}_{0} + {m}_{t} y + \sqrt{{δ}_{t}} {ϵ}_{t} \qquad [ Equation 5 ]$$

$${x}_{t - 1} = ( 1 - {m}_{t - 1} ) {x}_{0} + {m}_{t} y + \sqrt{{δ}_{t - 1}} {ϵ}_{t - 1} \qquad [ Equation 6 ]$$

$$Where {ϵ}_{t} , {ϵ}_{t - 1} ∼ 𝒩 ( 0 , I ) ..$$

The transition probability q_{BB}(xₜ|xₜ₋₁, y) may be derived as in [Equation 7] below by replacing the representation of x0 in [Equation 5] with a corresponding formula in [Equation 6].

$${q}_{BB} ( {x}_{t} \vert {x}_{t - 1} , y ) = 𝒩 ( {x}_{t} ; \frac{1 - {m}_{t}}{1 - {m}_{t - 1}} {x}_{t - 1} + ( {m}_{t} - \frac{1 - {m}_{t}}{1 - {m}_{t - 1}} {m}_{t - 1} ) y , {δ}_{t \vert t - 1} I ) \qquad [ Equation 7 ]$$

$$Where {δ}_{t \vert t - 1} = {δ}_{t} - {δ}_{t - 1} \frac{{( 1 - {m}_{t} )}^{2}}{{( 1 - {m}_{t - 1} )}^{2}} .$$

According to [Equation 7], when the forward diffusion process reaches the destination (t=T), mT=1 and xT=y. That is, the forward diffusion process defines fixed mapping from domain A to domain B.

Hereinafter, the image-to-image translation method based on the forward diffusion process of the Brownian bridge will be described in more detail.

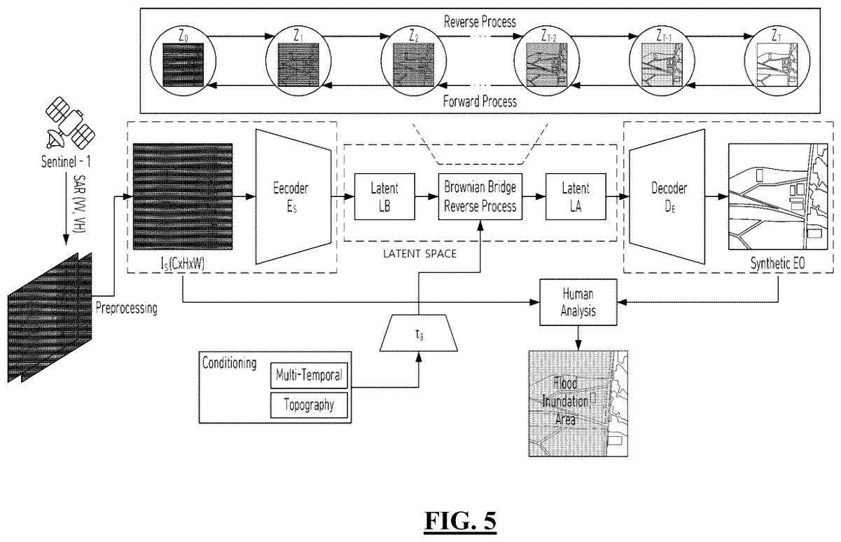

FIG. 5 is a block diagram of an image translation system according to an exemplary embodiment of the present disclosure.

In the present disclosure, (x,y) represents a training data pair in domain A and domain B. That is, x may mean an image of a target domain A and y may mean an image of a source domain B. The image of the target domain A may be the EO satellite image, and the image of the source domain B may be the SAR satellite image. In order to accelerate training and inference processes, the diffusion process is performed in the latent space of the VQGAN. Corresponding latent features may be represented by using x and y (i.e., x:=LA(x), y:=LB(y)).

Since the image translation system is a model that predicts the EQ satellite image with the ground truth image from the SAR satellite image in the image-to-image translation task of the present disclosure, when the diversity of the diffusion model is high, accurate prediction is difficult, and there may be rather an inference element in the process of reading the image by the person. That is, in the image-to-image translation task of the present disclosure, a prediction which closely matches the actual EO satellite image is more important than the diversity.

Accordingly, in the present disclosure, a term Ft which is a term of controlling the diversity is modified in the diffusion model in [Equation 5] to make the image-to-image translation task be closer to the prediction. As an example, noise εt and εt1 added to an input image may be sampled in the distribution of the source domain other than a standard normal distribution N(0, I) in the forward diffusion process. This is expressed as shown in [Equation 8] below.

$$ε t , ε t - 1 ∼ N ( 0 , I ) \to ε t ∼ B ( N ( 0 , I ) ) \qquad [ Equation 8 ]$$

B(N(0,I)) means converting standard Gaussian noise N(0, I) into source domain noise. That is, B(N(0,I)) means converting the mean and the dispersion of the standard normal distribution into the mean and the dispersion of the distribution of the source domain. Accordingly, the distribution of the source domain may be referred to as noise of a modified version.

Since the noise εt and εt1 added to the input image in the forward diffusion process may be sampled in the distribution of the source domain, the diffusion model trains fixed mapping from the target domain A to the source domain B in the latent space.

### Forward Diffusion Process

In the front diffusion process, the diffusion model may add the noise sampled in the distribution of the source domain to the image of the target domain A for each step. That is, the forward diffusion process may mean that the noise εt added to the image is sampled in the distribution of the source domain other than the standard normal distribution in [Equation 5].

Specifically, the diffusion model may extract a latent feature LA of the target domain A from the image of the target domain A. The diffusion model adds the noise sampled in the distribution of the source domain to the latent feature LA of the target domain A to convert the latent feature LA of the target domain A into a latent representation of the source domain B.

### Reverse Diffusion Process

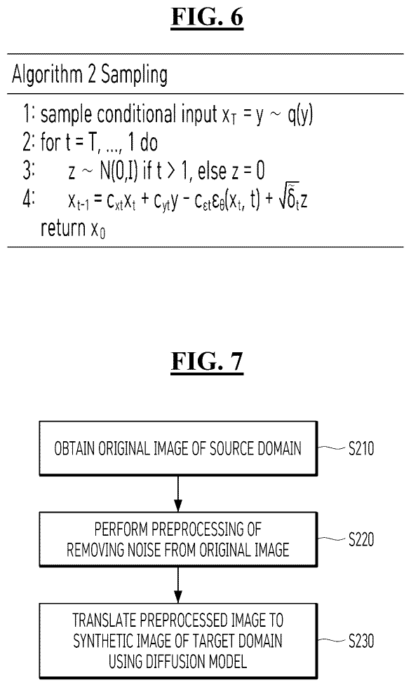

FIG. 6 is a diagram for describing a sampling process according to an exemplary embodiment of the present disclosure.

In the reverse diffusion process, the diffusion model may remove estimated noise in a reference image of the source domain B for each step, and set random noise added for each step to 0.

As described in the Brownian bridge diffusion model, \sqrt{δₜ} of FIG. 6 may correspond to a term of controlling the diversity in the diffusion model. In addition, the added random noise (i.e., ε included in z) is set to 0 to make the image-to-image translation task be closer to the prediction.

Referring back to FIG. 5, in the reverse diffusion process, the computing device 100 may train the diffusion model with additional information of the image of the source domain A as a condition. As an example, the image of the source domain may include multi-temporal images which are spatially registered and temporally randomly selected. In this case, the additional information of the image of the source domain A may include temporal information of the image of the source domain. In some exemplary embodiments, the additional information of the image of the source domain may include topographical information of the image of the source domain.

Specifically, the computing device 100 may project the additional information of the image of the source domain to an intermediate representation of Unet. The diffusion model may map the projection result to an intermediate layer of the Unet through a cross attention layer.

### Inference Step

FIG. 7 is a flowchart for describing a method of performing image-to-image translation using a diffusion model according to an exemplary embodiment of the present disclosure.

The computing device 100 may obtain an original image of a source domain (S210). The computing device 100 may obtain a VV channel signal and a VH channel signal observed in a sensor of an SAR satellite, and generate a VV, VH, and (VV+VH)/2 type 3-channel images using the obtained channel signals.

The computing device 100 may perform preprocessing of removing noise of the original image through self-supervised denoising (S220).

The computing device 100 may translate a preprocessed image to a synthetic image of a target domain by using a diffusion model (S230). The diffusion model may be a model trained to translate an SAR satellite image to an EO satellite image. The computing device 100 gradually removes noise from the preprocessed image through a pre-trained denoising process to translate the preprocessed image to the synthetic image of the target domain.

Referring back to FIG. 5, specifically, the computing device 100 may extract a latent feature LB of the preprocessed image by using an encoder. The computing device 100 may map the latent feature to a corresponding latent representation in the target domain through the trained denoising process. The computing device 100 may generate the synthetic image of the target domain based on the latent feature of the target domain by using a decoder.

### Preprocessing

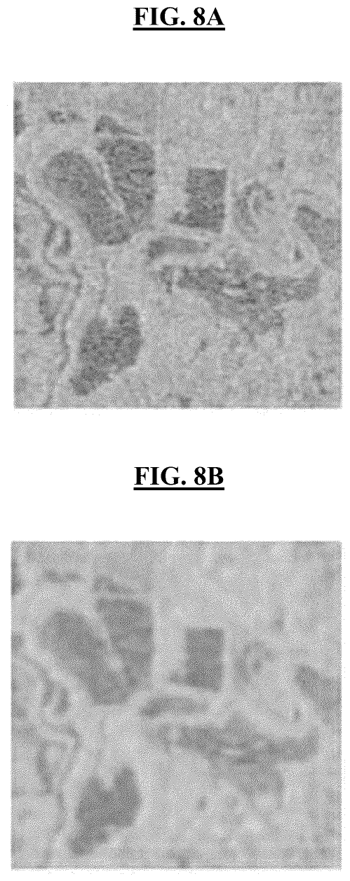

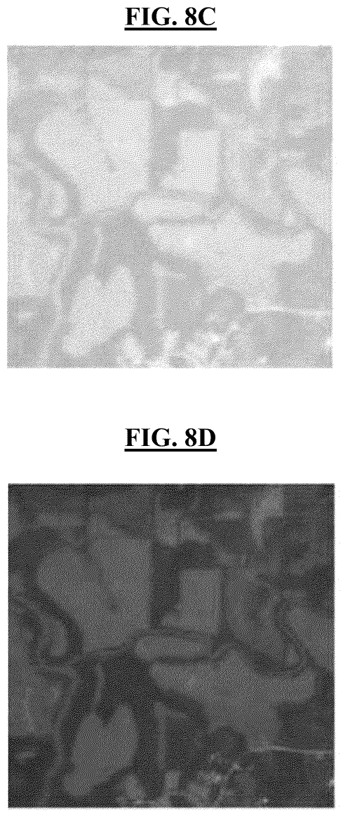

FIGS. 8A, 8B, 8C, and 8D are diagrams for describing an image from which noise is removed using a self supervised scheme according to an exemplary embodiment of the present disclosure.

Referring to FIG. 8A, in the SAR satellite image, a speckle phenomenon intrinsically occurs according to a generation scheme, and the SAR satellite image may be represented by a mathematical model for multiple speckle noise N described below.

Y=XN

Where Y represents an observed SAR intensity, X represents a clean image (or speckle-free image), and N represents the speckle noise.

In general, it is assumed that the speckle noise follows a Gamma distribution in which a mean is 1 and a dispersion is 1/L, and here, L represents the number of looks in a multi-look process. A probability density function of such a specific distribution may be defined as follows.

$$\begin{matrix}[ Equation 9 ] & \\ p ( N ) = \frac{1}{Γ ( N )} {L}^{N} {N}^{L - 1} {e}^{- L N} , & ( 6 )\end{matrix}$$

Where Γ(·) represents a Gamma function. In [Equation 9] above, characteristics of the speckle noise in the SAR satellite image are described more comprehensively. In a diffusion based image-to-image translation model, the SAR image and the added noise are predicted jointly during the forward diffusion process. However, the model has a difficulty in distinguishing unique speckle noise of the SAR satellite image and the additional noise introduced during the forward diffusion process as in [Equation 9] above. Accordingly, a residue of the noise may remain even after the image is translated as shown in FIG. 8C.

In order to solve such a problem, before inputting the image into the diffusion model in the image-to-image translation process, noise is removed by using a blind-spot based self-supervised denoising method in the SAR satellite image. It is assumed that noise is generally independent of a clean image in a traditional blind-spot based approach method. This is a condition which is not satisfied in the SAR satellite image generated through [Equation 9]. In order to alleviate this, the noise of the SAR satellite image may be removed using the blind-spot based self-supervised denoising method which is a transformation of a blind-spot technology, which uses various kernels in the present disclosure. FIG. 8B illustrates a denoising result using the blind-spot based self-supervised denoising method, and FIG. 8D illustrates an image translation result using an SAR satellite image from which noise is removed. Accordingly, when image translation is performed using the SAR satellite image from which noise is removed, a clear and accurate result may be acquired.

By a method of performing preprocessing of removing noise from an original image, masked features may be extracted from the original image by using a plurality of convolutional kernels masked with different shapes. The masked features are combined to acquire a fused feature. The noise of the original image may be removed by using the fused feature.

### Additional Information

When the image-to-image translation is performed by using the diffusion model, additional information of the original image is input into the diffusion model as a condition to translate the preprocessed image Is into a synthetic image EO of the target domain.

The additional information of the original image may include temporal information of the original image or topographical information of the original image. As an example, when the original image includes multi-temporal images which are spatially registered and temporally randomly selected, the additional information input into the diffusion model may be temporal information of the original image.

The additional information of the original image may be semantically compressed by the encoder, and input as the condition in a denoising process.

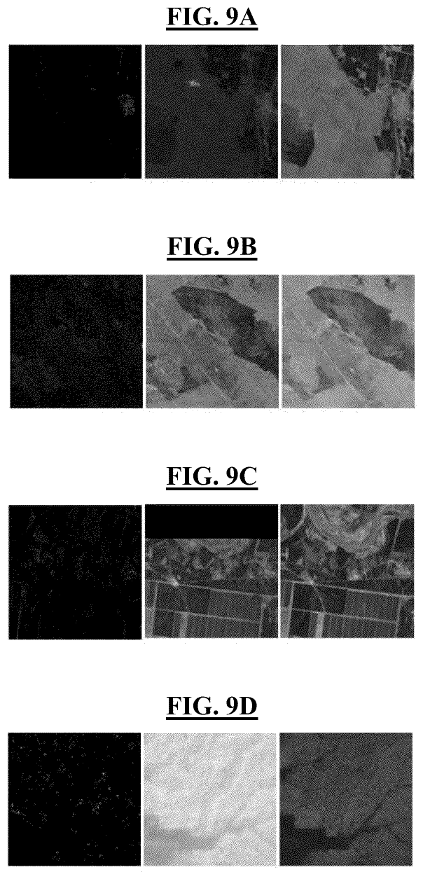

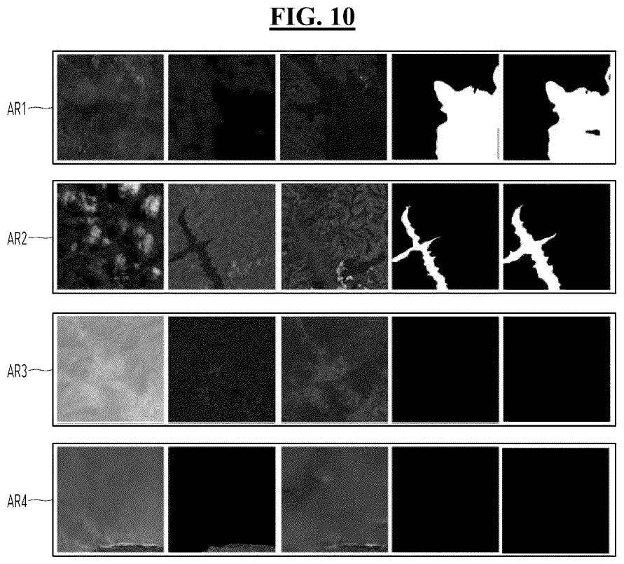

FIGS. 9A, 9B, 9C, and 9D are diagrams for describing a synthetic EO satellite image generated through the method of image-to-image translation according to an exemplary embodiment of the present disclosure.

In each of FIGS. 9A, 9B, 9C, and 9D, a left drawing illustrates the SAR satellite image, a central drawing illustrates the EO satellite image, and a right drawing illustrates the synthetic EO satellite image.

The image-to-image translation method of the present disclosure achieves a high performance (peak signal-to-noise ratio (PSNR)) in terms of the accuracy of the generated EO image.

Referring to FIG. 9C, the image-to-image translation method of the present disclosure, it is possible to generate missing area (e.g., an image which is covered with clouds or in which is impossible to observe at night time) of the EO satellite image from the SAR satellite image. Further, a registered image between the SAR satellite image and the EO satellite image only with the SAR satellite image in real time may be obtained by using a trained deep learning model.

FIG. 10 is a diagram for describing a synthetic EO satellite image generated through the method of image-to-image translation according to an exemplary embodiment of the present disclosure.

In FIG. 10, for each of AR1, AR2, AR3, and AR4, in order from left drawing to right drawing, it shows the EO satellite image, the SAR satellite image, the synthetic EO satellite image, expert decoding result, and flood labeling.

The image-to-image translation method of the present disclosure achieves a high performance (peak signal-to-noise ratio (PSNR)) in terms of the accuracy of the generated EO image.

In the meantime, according to an embodiment of the present disclosure, a computer readable medium storing a data structure is disclosed.

The data structure may refer to organization, management, and storage of data that enable efficient access and modification of data. The data structure may refer to organization of data for solving a specific problem (for example, data search, data storage, and data modification in the shortest time). The data structure may also be defined with a physical or logical relationship between the data elements designed to support a specific data processing function. A logical relationship between data elements may include a connection relationship between user defined data elements. A physical relationship between data elements may include an actual relationship between the data elements physically stored in a computer readable storage medium (for example, a permanent storage device). In particular, the data structure may include a set of data, a relationship between data, and a function or a command applicable to data. Through the effectively designed data structure, the computing device may perform a calculation while minimally using resources of the computing device. In particular, the computing device may improve efficiency of calculation, reading, insertion, deletion, comparison, exchange, and search through the effectively designed data structure.

The data structure may be divided into a linear data structure and a non-linear data structure according to the form of the data structure. The linear data structure may be the structure in which only one data is connected after one data. The linear data structure may include a list, a stack, a queue, and a deque. The list may mean a series of dataset in which order exists internally. The list may include a linked list. The linked list may have a data structure in which data is connected in a method in which each data has a pointer and is linked in a single line. In the linked list, the pointer may include information about the connection with the next or previous data. The linked list may be expressed as a single linked list, a double linked list, and a circular linked list according to the form. The stack may have a data listing structure with limited access to data. The stack may have a linear data structure that may process (for example, insert or delete) data only at one end of the data structure. The data stored in the stack may have a data structure (Last In First Out, LIFO) in which the later the data enters, the sooner the data comes out. The queue is a data listing structure with limited access to data, and may have a data structure (First In First Out, FIFO) in which the later the data is stored, the later the data comes out, unlike the stack. The deque may have a data structure that may process data at both ends of the data structure.

The non-linear data structure may be the structure in which the plurality of data is connected after one data. The non-linear data structure may include a graph data structure. The graph data structure may be defined with a vertex and an edge, and the edge may include a line connecting two different vertexes. The graph data structure may include a tree data structure. The tree data structure may be the data structure in which a path connecting two different vertexes among the plurality of vertexes included in the tree is one. That is, the tree data structure may be the data structure in which a loop is not formed in the graph data structure.

The data structure may include a neural network. Further, the data structure including the neural network may be stored in a computer readable medium. The data structure including the neural network may also include preprocessed data for processing by the neural network, data input to the neural network, a weight of the neural network, a hyper-parameter of the neural network, data obtained from the neural network, an active function associated with each node or layer of the neural network, and a loss function for training of the neural network. The data structure including the neural network may include predetermined configuration elements among the disclosed configurations. That is, the data structure including the neural network may include the entirety or a predetermined combination of pre-processed data for processing by neural network, data input to the neural network, a weight of the neural network, a hyper parameter of the neural network, data obtained from the neural network, an active function associated with each node or layer of the neural network, and a loss function for training the neural network. In addition to the foregoing configurations, the data structure including the neural network may include predetermined other information determining a characteristic of the neural network. Further, the data structure may include all type of data used or generated in a computation process of the neural network, and is not limited to the foregoing matter. The computer readable medium may include a computer readable recording medium and/or a computer readable transmission medium. The neural network may be formed of a set of interconnected calculation units which are generally referred to as “nodes”. The “nodes” may also be called “neurons.” The neural network consists of one or more nodes.

The data structure may include data input to the neural network. The data structure including the data input to the neural network may be stored in the computer readable medium. The data input to the neural network may include training data input in the training process of the neural network and/or input data input to the training completed neural network. The data input to the neural network may include data that has undergone pre-processing and/or data to be pre-processed. The pre-processing may include a data processing process for inputting data to the neural network. Accordingly, the data structure may include data to be pre-processed and data generated by the pre-processing. The foregoing data structure is merely an example, and the present disclosure is not limited thereto.

The data structure may include a weight of the neural network (in the present specification, weights and parameters may be used with the same meaning), Further, the data structure including the weight of the neural network may be stored in the computer readable medium. The neural network may include a plurality of weights. The weight is variable, and in order for the neural network to perform a desired function, the weight may be varied by a user or an algorithm. For example, when one or more input nodes are connected to one output node by links, respectively, the output node may determine a data value output from the output node based on values input to the input nodes connected to the output node and the weight set in the link corresponding to each of the input nodes. The foregoing data structure is merely an example, and the present disclosure is not limited thereto.

For a non-limited example, the weight may include a weight varied in the neural network training process and/or the weight when the training of the neural network is completed. The weight varied in the neural network training process may include a weight at a time at which a training cycle starts and/or a weight varied during a training cycle. The weight when the training of the neural network is completed may include a weight of the neural network completing the training cycle. Accordingly, the data structure including the weight of the neural network may include the data structure including the weight varied in the neural network training process and/or the weight when the training of the neural network is completed. Accordingly, it is assumed that the weight and/or a combination of the respective weights are included in the data structure including the weight of the neural network. The foregoing data structure is merely an example, and the present disclosure is not limited thereto.

The data structure including the weight of the neural network may be stored in the computer readable storage medium (for example, a memory and a hard disk) after undergoing a serialization process. The serialization may be the process of storing the data structure in the same or different computing devices and converting the data structure into a form that may be reconstructed and used later. The computing device may serialize the data structure and transceive the data through a network. The serialized data structure including the weight of the neural network may be reconstructed in the same or different computing devices through deserialization. The data structure including the weight of the neural network is not limited to the serialization. Further, the data structure including the weight of the neural network may include a data structure (for example, in the non-linear data structure, B-Tree, Trie, m-way search tree, AVL tree, and Red-Black Tree) for improving efficiency of the calculation while minimally using the resources of the computing device. The foregoing matter is merely an example, and the present disclosure is not limited thereto.

The data structure may include a hyper-parameter of the neural network. The data structure including the hyper-parameter of the neural network may be stored in the computer readable medium. The hyper-parameter may be a variable varied by a user. The hyper-parameter may include, for example, a learning rate, a cost function, the number of times of repetition of the training cycle, weight initialization (for example, setting of a range of a weight value to be weight-initialized), and the number of hidden units (for example, the number of hidden layers and the number of nodes of the hidden layer). The foregoing data structure is merely an example, and the present disclosure is not limited thereto.

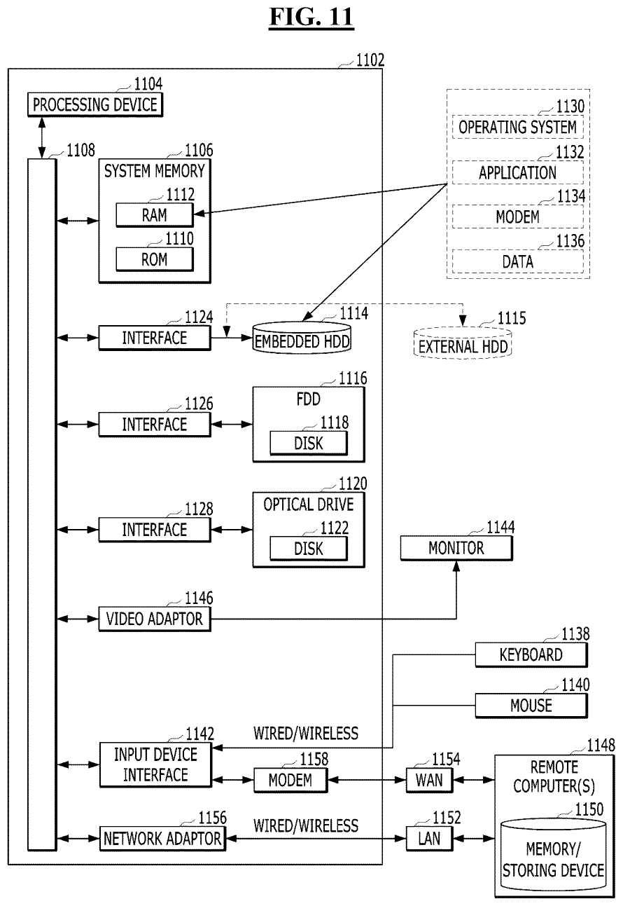

FIG. 11 is a simple and general schematic diagram illustrating an example of a computing environment in which the embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transport medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented embodiments is provided so as for those skilled in the art to use or carry out the present disclosure. Various modifications of the embodiments may be apparent to those skilled in the art, and general principles defined herein may be applied to other embodiments without departing from the scope of the present disclosure. Accordingly, the present disclosure is not limited to the embodiments suggested herein, and shall be interpreted within the broadest meaning range consistent to the principles and new characteristics presented herein.

What is claimed is:

1. A method for training a diffusion model for image-to-image translation, the method being performed by a computing device, the method comprising:
obtaining an image of a target domain;
sampling random noise from a distribution of a source domain; and
training a diffusion model that translates an image of the source domain to the image of the target domain based on the sampled noise.

2. The method of claim 1, further comprising:
generating the distribution of the source domain by converting a mean and a dispersion of a standard normal distribution into a mean and a dispersion of the distribution of the source domain.

3. The method of claim 1, wherein the training of the diffusion model includes:
training mapping from the target domain to the source domain in a latent space.

4. The method of claim 3, wherein the training of mapping from the target domain to the source domain in the latent space includes:
adding the sampled noise to the image of the target domain for each step in a forward diffusion process, and
removing estimated noise from a reference image of the source domain for each step in a reverse diffusion process.

5. The method of claim 4, further comprising:
setting random noise added for the each step to 0 in the reverse diffusion process.

6. The method of claim 4, wherein the adding of the sampled noise to the image of the target domain includes:
extracting a latent feature of the target domain from the image of the target domain, and
converting the latent feature of the target domain into a latent representation of the source domain by adding the sampled noise to the latent feature of the target domain.

7. The method of claim 1, wherein the training of the diffusion model includes:
training the diffusion model by using additional information of an image of the source domain as a condition in a reverse diffusion process.

8. The method of claim 7, wherein the training of the diffusion model by using the additional information of the image of the source domain as the condition includes:
projecting the additional information of the image of the source domain to an intermediate representation of Unet, and
mapping the projection result to an intermediate layer of the Unet through a cross attention layer.

9. The method of claim 7, wherein the image of the source domain includes multi-temporal images which are spatially registered and temporally randomly selected.

10. The method of claim 9, wherein the additional information of the image of the source domain includes temporal information of the image of the source domain or topographical information of the image of the source domain.

11. A method of performing image-to-image translation using a diffusion model, the method being performed by a computing device, the method comprising:
obtaining an original image of a source domain;
performing preprocessing of removing noise from the original image; and
translating the preprocessed image to a synthetic image of a target domain by using a diffusion model,
wherein the diffusion model translates the preprocessed image to the synthetic image of the target domain by gradually removing noise from the preprocessed image through a trained denoising process.

12. The method of claim 11, wherein the diffusion model is a model trained to translate a synthetic aperture radar (SAR) satellite image to an electro-optical (EO) satellite image.

13. The method of claim 11, wherein the performing of the preprocessing of removing the noise from the original image includes:
extracting masked features from the original image by using a plurality of convolutional kernels masked with different shapes,
obtaining a fused feature by combining the masked features, and
removing the noise from the original image by using the fused feature.

14. A computing device comprising:
at least one processor; and
a memory,
wherein the at least one processor is configured to:
obtain an image of a target domain,
sample random noise from a distribution of a source domain, and
train a diffusion model that translates an image of the source domain to the image of the target domain based on the sampled noise.

15. The computing device of claim 14, wherein the at least one processor is further configured to:
generate the distribution of the source domain by converting a mean and a dispersion of a standard normal distribution into a mean and a dispersion of the distribution of the source domain.

16. The computing device of claim 14, wherein the at least one processor is further configured to:
train mapping from the target domain to the source domain in a latent space.

17. The computing device of claim 16, wherein the at least one processor is further configured to:
add the sampled noise to the image of the target domain for each step in a forward diffusion process, and
remove estimated noise from a reference image of the source domain for each step in a reverse diffusion process.

18. The computing device of claim 17, wherein the at least one processor is further configured to:
set random noise added for the each step to 0 in the reverse diffusion process.

19. The computing device of claim 14, wherein the at least one processor is further configured to:
train the diffusion model by using additional information of an image of the source domain as a condition in the reverse diffusion process.

20. The computing device of claim 19, wherein the additional information of the image of the source domain includes temporal information of the image of the source domain or topographical information of the image of the source domain.
